(19) United States
(12) Patent Application Publication
(10) Pub. No.: US 2006/0044415 A1
(43) Pub. Date: Mar. 2, 2006

(54) Camera system

(75) Inventor: Keiichiro Takahashi, Asaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 11/210,754

(22) Filed: Aug. 25, 2005

(30) Foreign Application Priority Data
Aug. 26, 2004 (JP) 2004-246619

(51) Int. Cl. H04N 5/235

(52) U.S. Cl. 348/230.1

(57) ABSTRACT

The present invention provides a camera system including plural camera heads and a camera main unit to which any of the camera heads is attached. Each of the camera heads includes a sensitivity information storing unit. Each time any one of the camera heads is attached to the camera main unit, a CPU of the camera main unit obtains sensitivity information stored in the sensitivity information storing unit. Based on the obtained information, the CPU causes a LCD unit to display a sensitivity settable range on a display screen so as to inform a user of the property of the CCD of the camera head.

### BACKGROUND OF THE INVENTION

1. Field of the Invention

The present invention relates to a camera system including: plural types of camera heads each incorporating therein an image taking optical system and an image pickup device and having a sensitivity settable range unique to each of the camera heads; and a camera main unit to which any of the plural types of camera heads is interchangeably attached and which receives an image signal from the attached camera head and performs signal processing.

2. Description of the Related Art

There has been proposed a camera system including a camera main unit and a plug-in unit incorporating an image pickup device and an image taking optical system integrally, in which, once the plug-in unit is attached to the camera main unit, information retained in the plug-in unit is transmitted to the camera main unit to enable image taking using the image taking optical system of the plug-in unit (see Japanese Patent Application No. 8-172561). Such a camera system, in which the image taking optical system, that is, the image taking lens, can be changed simply by attaching the plug-in unit to the camera main unit, is quite easy to handle and permits a person who has no expertise in camera system to easily change the image taking lens.

There has been proposed a similar camera system that includes: a camera head having an image taking optical system and an image pickup device; and a camera main unit to which a camera head is removably attached and which receives an image signal from the attached camera head and performs signal processing (see Japanese Patent Application No. 2000-187268 for example).

Recently, various types of image pickup devices have been introduced and the properties of image pickup devices including sensitivity have become diversified as well. When a camera head provided with any of such various types of image pickup devices is attached to a camera main unit, the camera main unit is given no information about the properties of the image pickup device including sensitivity until the camera head is attached to the camera main unit. There is proposed a technique to avoid such a situation (see Japanese Patent Application No. 2004-85795 for example). In this technique, an image pickup device sends its sensitivity information to a control unit of a camera main unit to allow the control unit to precisely calculate exposure. However, because this is a technique applied to a back interchangeable camera that includes an electronic still back having an image pickup device, this is not applicable to a camera system that includes a camera head having an image pickup device.

Also, when using such various types of image pickup devices, a user needs to read the manual to find out information such as a sensitivity settable range of the image pickup device of a camera head before attaching the camera head to a camera main unit. If the user takes an image by setting an unacceptable sensitivity value without looking up the information in the manual, the user can only later learn the fact that the image taking has failed.

### SUMMARY OF THE INVENTION

The present invention has been made in view of the above circumstances, and provides a camera system that allows a user to properly take an image within a sensitivity settable range of an image pickup device of an attached camera head.

A camera system according to the present invention includes: plural types of camera heads each incorporating therein an image taking optical system and an image pickup device and having a sensitivity settable range unique to each one of the camera heads; and a camera main unit to which any of the plural types of camera heads is interchangeably attached and which receives an image signal from the attached camera head and performs signal processing,

wherein the camera head includes:

a sensitivity range recognition section that recognizes a sensitivity settable range of a camera head attached to the main unit; and

a display section that displays contents according to the sensitivity settable range recognized by the sensitivity range recognition section.

With this structure, the sensitivity range recognition section of the camera main unit recognizes a sensitivity settable range of the camera head when the camera head is attached, and the recognized range is displayed by the display section so that a user can see the correct sensitivity settable range.

When a user is visually informed of a sensitivity settable range in this manner, the user can take an image using a correct sensitivity value within the sensitivity settable range simply by checking the sensitivity settable range displayed by the display section. In addition, since the sensitivity settable range of the image pickup device of the attached camera head is correctly recognized by the sensitivity range recognition section, besides such a visual notice of the sensitivity settable range by the display section, it is possible to give a warning by a sound to the user who is about to take an image with an unsettable sensitivity value.

In the above camera system, preferably, the display section displays settable sensitivity values, and

the camera main unit includes:

a sensitivity setting section that sets any of the settable sensitivity values according to an operation; and

an image taking section that takes an image with the sensitivity value set by the sensitivity setting section.

This allows an image to be taken by the image taking section with the sensitivity value set by the sensitivity setting section.

In the above camera system, preferably, the display section displays, in addition to the settable sensitivity values, unsettable sensitivity values in a mode distinguished from the settable sensitivity values.

This allows a user to easily find settable and unsettable sensitivity values because the display section displays the settable and unsettable sensitivity values by distinguishing them from each other.

Further, preferably, the display section displays settable exposure correction values, and the camera main unit includes:

an exposure correction setting section that sets any of the settable exposure correction values according to an operation; and

an image taking section that takes an image with exposure corrected according to the exposure correction value set by the exposure correction setting section.

Preferably, this display section displays, in addition to the settable exposure correction values, unsettable exposure correction values in a mode distinguished from the settable exposure correction values.

Furthermore, preferably, the display section displays settable shutter speeds, and

the camera main unit includes:

a shutter speed setting section that sets any of the settable shutter speeds according to an operation; and

an image taking section that takes an image at the shutter speed set by the shutter speed setting section.

Preferably, this display section displays, in addition to the settable shutter speeds, unsettable shutter speeds in a mode distinguished from the settable shutter speeds.

As described above, the present invention realizes a camera system for allowing a user to correctly take an image within a sensitivity settable range of the image pickup device of an attached camera head.

### BRIEF DESCRIPTION OF THE DRAWINGS

FIG. 1 is a diagram showing a camera system according to an embodiment of the present invention;

FIG. 2 is an external view of the camera system in which a camera head as one of plural types of camera heads is attached to a camera main unit as one of plural types of camera main units;

FIG. 3 is a block diagram showing the internal structure of the camera system in a state that the camera head is attached to the camera main unit;

FIG. 4 is diagram showing a display screen that displays a sensitivity settable range of a CCD of the attached camera head;

FIG. 5 is a flowchart showing a flow of procedures performed by the CPU;

FIG. 6 is a block diagram showing another example of the internal structure of the camera system, which is provided with a sensitivity/shutter speed information storing unit for storing sensitivity/shutter speed information;

FIG. 7 shows a display screen that displays a shutter-speed settable range;

FIG. 8 is a block diagram showing yet another example of the internal structure of the camera system, which provides a shutter-speed/aperture/CCD-sensitivity storing unit that stores aperture information in place of the sensitivity/shutter speed information storing unit shown in FIG. 6; and

FIG. 9 shows a display screen that displays an exposure-correction-value settable range.

### DETAILED DESCRIPTION OF THE INVENTION

In the following, an embodiment of the present invention will be described.

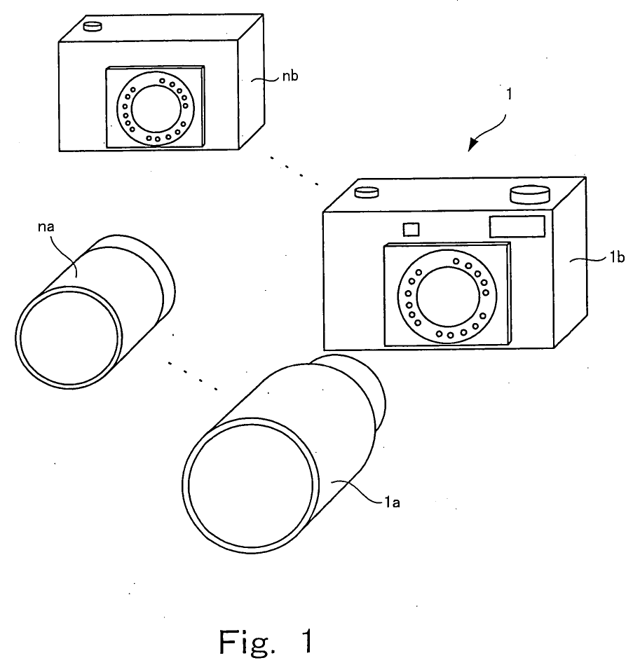

FIG. 1 shows a camera system according to an embodiment of the present invention.

A camera system according to the present invention will be described assuming that the camera system includes plural types of interchangeable camera heads 1a through na and plural types of interchangeable camera main units 1b through nb, and that the camera system is configured such that any (e.g. 1a) of the plural types of camera heads is attached to any (e.g. 1b) of the plural types of camera main units.

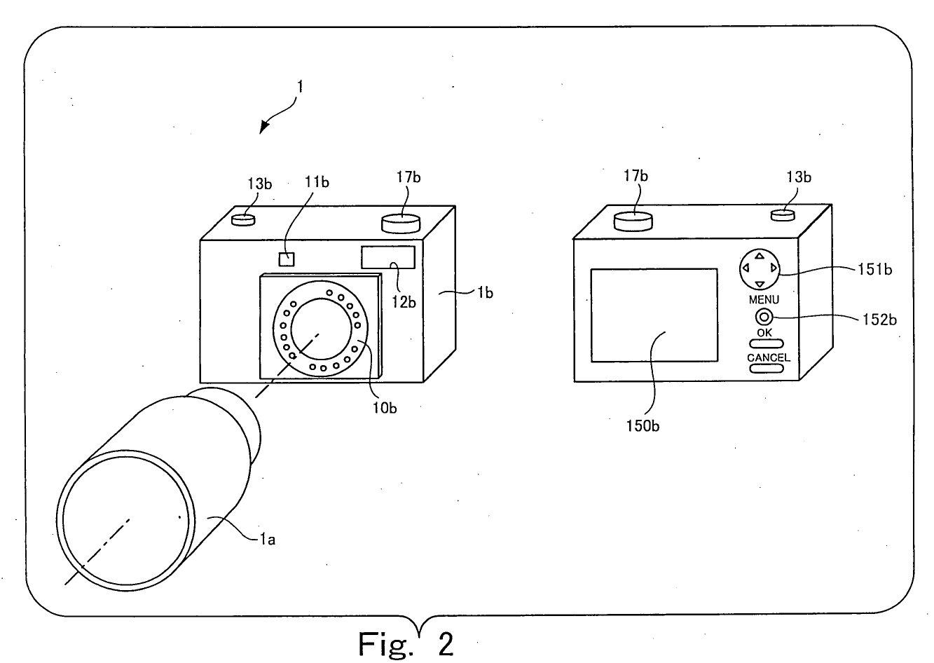

FIG. 2 is an external view of the camera system 1 in which the camera head 1a as one of the plural types of camera heads is attached to the camera main unit 1b as one of the plural types of camera main units.

FIG. 2 shows the camera head 1a that includes an image taking optical system and an image pickup device and the camera main unit 1b that receives an image signal from the camera head 1a and performs signal processing when the camera head 1a is attached, which are separately illustrated.

As shown in FIG. 2, a head mount 10b is provided in the center of the camera main unit 1b having multiple mount contacts. The camera head 1a is also provided with similar multiple mount contacts. Once the camera head 1a is mechanically attached to the camera main unit 1b along the chain line shown in FIG. 2 by aligning the mount contacts of the camera head 1a with those of the camera main unit 1b, each of the mount contacts is connected to corresponding one, and the camera head 1a and the camera main unit 1b are electrically connected to each other.

The camera system 1 is configured such that the camera main unit 1b has a battery and the power is supplied from the battery through mount contacts for power supply among the multiple contacts of the camera main unit 1b and the camera head 1a. Once the power is supplied from the battery of the camera main unit 1b to the camera head 1a, the camera head 1a and the camera main unit 1b both enter the active state.

Besides the mount contacts for power supply, the multiple mount contacts include mount contacts for control, through which, the camera main unit 1b reads information such as CCD sensitivity information of the camera head 1a.

Disposed on the top surface of the camera main unit 1b are a release button 13b and a mode dial 17b. The mode dial 17b is used to select an image taking mode, a replay mode, or the like. On the back surface of the camera main unit 1b shown in FIG. 2, there are disposed a LCD panel 150b for displaying images and operation keys such as a cross key 151b, a menu key 152b, etc. Upon operation of the menu key 152b and selection of an item “sensitivity” from selection items by using the cross key 151b, a sensitivity settable range unique to the attached camera head 1a is displayed. The details will be described later.

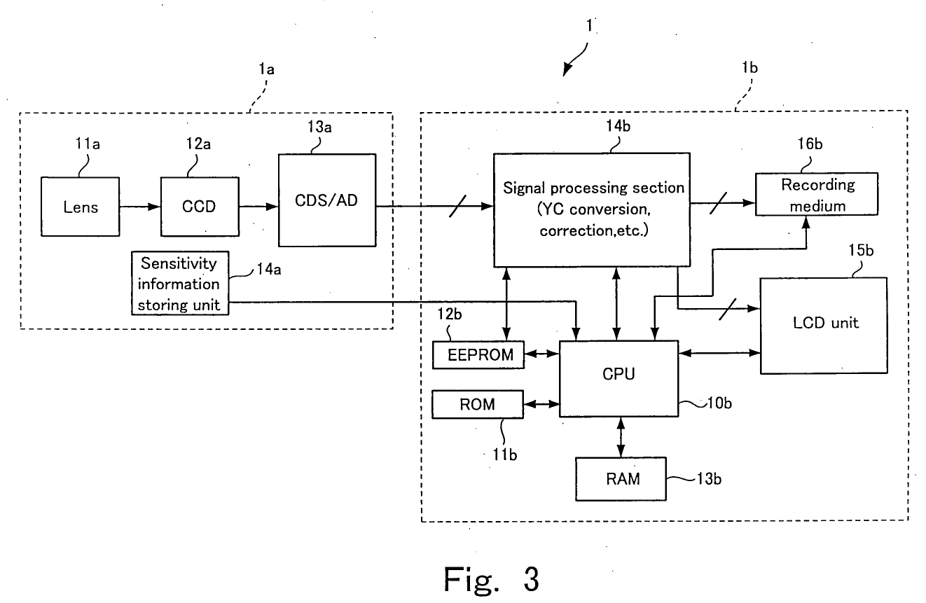

Now, the internal structure of the camera system shown in FIG. 2 will be briefly described with reference to FIG. 3.

FIG. 3 is a block diagram showing the internal structure of the camera system 1 in a state that the camera head 1a is attached to the camera main unit 1b. Only a system related to image-taking processing is extracted and illustrated in FIG. 3.

The left part of FIG. 3 shows the structure of the camera head 1a and the right part of FIG. 3 shows the structure of the camera main unit 1b.

First, the structure of the camera head 1a will be briefly described.

As shown in FIG. 3, the camera head 1a in the camera system 1 includes: a lens 11a and an image pickup device (which is a CCD solid image pickup device in this example and therefore will be hereinafter referred to as “CCD”) 12a. When an image of an object is formed on the CCD 12a by the lens 11a, the CCD 12a generates an image signal representing the image, and the CCD 12a outputs the image signal to a CDS/AD unit 13a upon completion of exposure. The CDS/AD unit 13a reduces noise, which is produced when the image signal is output from the CCD 12a, and converts the image signal from analog to digital form and supplies the digital image signal to the camera main unit 1b.

Upon receipt of the digital image signal, the camera main unit 1b applies signal processing to the received image signal by means of a signal processing unit 14b incorporated in the camera main unit 1b. The processed signal is recorded in a recording medium 16b and used to display the image on a display screen of a LCD unit 15b in the camera main unit 1b.

The camera main unit 1b includes a microcomputer that controls, in addition to the image-taking processing, processing for recording signals in the recording medium 16b and processing for displaying images on the display screen of the LCD unit 15b. The microcomputer is composed of a ROM 11b, a RAM 13b, a EEPROM 12b, and a CPU 10b. The microcomputer is configured such that the CPU 10b executes processing according to programs stored in the ROM 11b. The CPU 10b sequentially performs the processing while rewriting variables such as flags in the RAM as required during the execution of the processing and checking the progress of the processing.

Further, the camera head 1a shown in FIG. 3 is provided with a sensitivity information storing unit 14a that stores beforehand data representing the sensitivity information of the camera head 1a. This allows the signal processing unit 14b, which is comprised of components such as a DSP capable of performing processing in corporation with the CPU 10b, to perform suitable signal processing. After the camera head 1a is attached to the camera main unit 1b, once the power is turned on by the mode dial 17b, the CPU 10b reads data that represents the CCD sensitivity information stored in the sensitivity information storing unit 14a and stores the read information in the RAM 13b of the camera main unit 1b. By obtaining the data that represents the CCD sensitivity information stored in the RAM 13b, the CPU 10b recognizes the sensitivity settable range of the CCD 12a incorporated in the camera head 1a. The CPU 10b corresponds to the “sensitivity range recognition section” according to the present invention.

Once the sensitivity settable range of the CCD 12a is recognized by the CPU 10b, data that represents the sensitivity settable range is stored in the RAM 13b and an operational parameter corresponding to one of the sensitivity values in the sensitivity settable range is set in the signal processing unit 14b. This makes it possible to perform appropriate signal processing according to the sensitivity of the CCD 12a incorporated in the camera head 1a. In addition, when a user operates the menu key 152b shown in FIG. 2 and selects “sensitivity” from the selection items by using the cross key 151b to see the currently set sensitivity value of the CCD 12a, the CPU 10b instructs the LCD unit 15b to display the sensitivity settable range on the display screen (LCD panel) 150b.

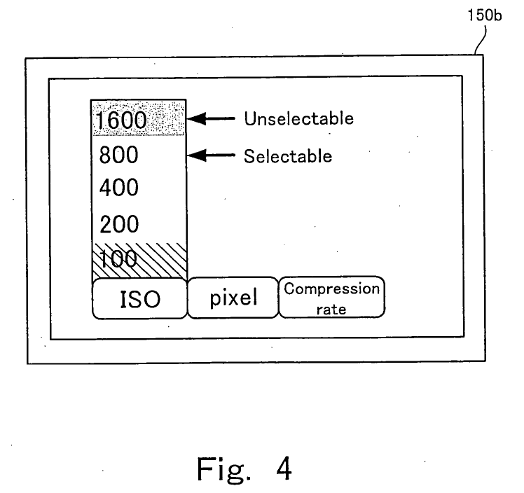

FIG. 4 shows the display screen 150b that displays the sensitivity settable range of the CCD 12a of the attached camera head 1a.

On the display screen 150b, a sensitivity unsettable range is displayed in addition to the sensitivity settable range for the attached camera head 1a. In this case, the unsettable range is indicated with a word e.g. “Unselectable” to distinguish it from the settable range. To clearly show the distinction between selectable and unselectable sensitivity values, the top item in the selectable sensitivity value list is indicated with a word: “Selectable.”

The above arrangement allows a user to quickly check the sensitivity settable range of the CCD provided in the attached camera head at a glance.

In addition, in this embodiment, the user can quickly check the currently set value (ISO 100 in the example shown in FIG. 4) that the user has selected by operating the cross key 151b.

When any one of ISO sensitivity values (ISO 100 in this case) other than 1600 is selected by operating the cross key 151b in this way, the CPU 10b sets data representing the selected sensitivity value as a parameter in the signal processing unit 14b and the signal processing unit 14b optimally performs signal processing to meet the selected sensitivity value. The combination of the camera head 1a and the signal processing unit 14b corresponds to the “image taking section” according to the present invention. In addition, the combination of the cross key 151b and the CPU 10b corresponds to the “sensitivity setting section” according to the present invention.

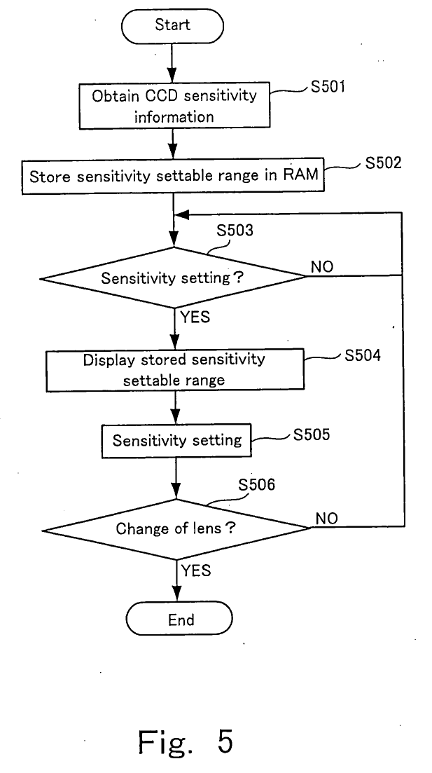

FIG. 5 is a flowchart showing a flow of procedures performed by the CPU 10b.

The procedures shown in FIG. 5 starts upon power-on after the camera head 1a is attached.

At step S501, the CPU 10b obtains CCD sensitivity information by reading it from the signal processing unit 14b. Subsequently, at step S502, the CPU 10b stores a sensitivity settable range in the RAM 13b and the flow goes to step S503.

When it is determined that the user has selected “sensitivity setting” from selection items by operating the menu key 152b and the cross key 151b at step S503, data representing the sensitivity settable range stored in the RAM 13b is supplied to the LCD unit 15b so that the sensitivity settable range is displayed on the display screen 150b (see FIG. 4) at step S504. Subsequently, at step S505, upon selection of a sensitivity value (ISO 100 in the example shown in FIG. 4), an operational parameter representing the selected sensitivity value is set in the signal processing unit 14b. At the subsequent step S506, if it is determined that the user has turned the power off to change the camera head 1a, the flow goes to YES and ends. If the power is left turned on without changing the camera head 1a and the camera is ready to take an image, the flow goes to NO and returns to step S503 to repeat the steps S503 through S506.

As described above, in a camera system according to the present invention, a user can properly take an image within a sensitivity settable range of the image pickup device of the attached camera head.

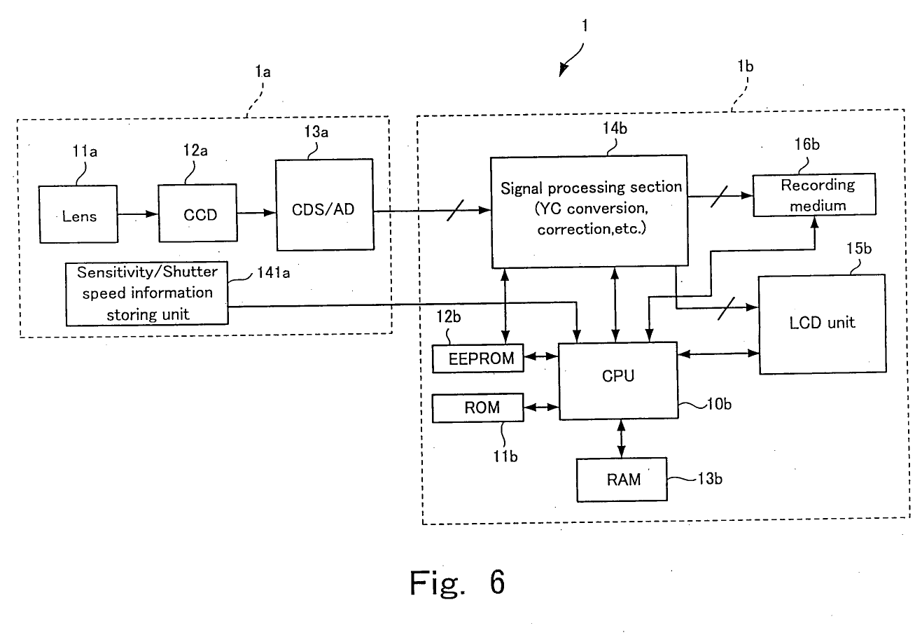

FIG. 6 is a block diagram showing another example of the internal structure of the camera system, which provides a sensitivity/shutter speed information storing unit 141a in place of the sensitivity information storing unit 14a shown in FIG. 3. The section 141a stores shutter speed information in addition to the sensitivity information.

The structure shown in FIG. 6 is the same as that shown in FIG. 3 except that it has the sensitivity/shutter speed information storing unit 141a in place of the sensitivity information storing unit 14a shown in FIG. 3. In this case, the CPU 10b controls a timing generator (not shown) for driving the CCD 12a of a camera head to supply the CCD 12a with a driving signal for a shutter speed selected by the cross key. The combination of the CPU 10b and the cross key corresponds to the “shutter speed setting section” according to the present invention.

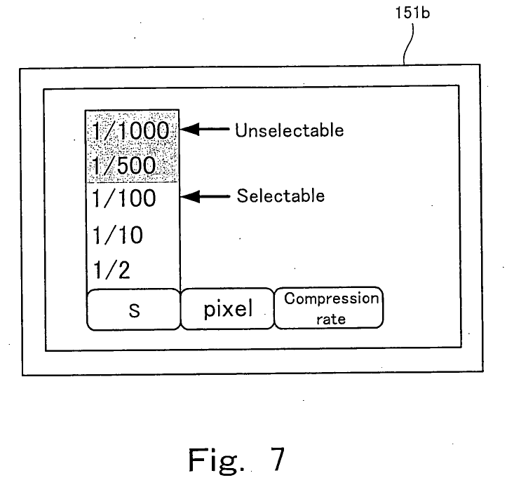

An example of a display screen in this structure is shown in FIG. 7.

FIG. 7 illustrates a display screen that displays a shutter-speed settable range.

In FIG. 7, shutter speeds (S) are displayed instead of the ISO sensitivity values shown FIG. 4. As with the ISO 1600 shown in FIG. 4, for example, a high shutter speed 1/1000 is displayed as a shutter speed at which an image cannot be taken. As with FIG. 4, an unselectable shutter speed is indicated with a word: “Unselectable.”

With this arrangement, a user can see a shutter speed setting range for an electronic shutter of the CCD at a glance and understand the shutter speed property of the electronic shutter of the CCD provided in an attached camera head.

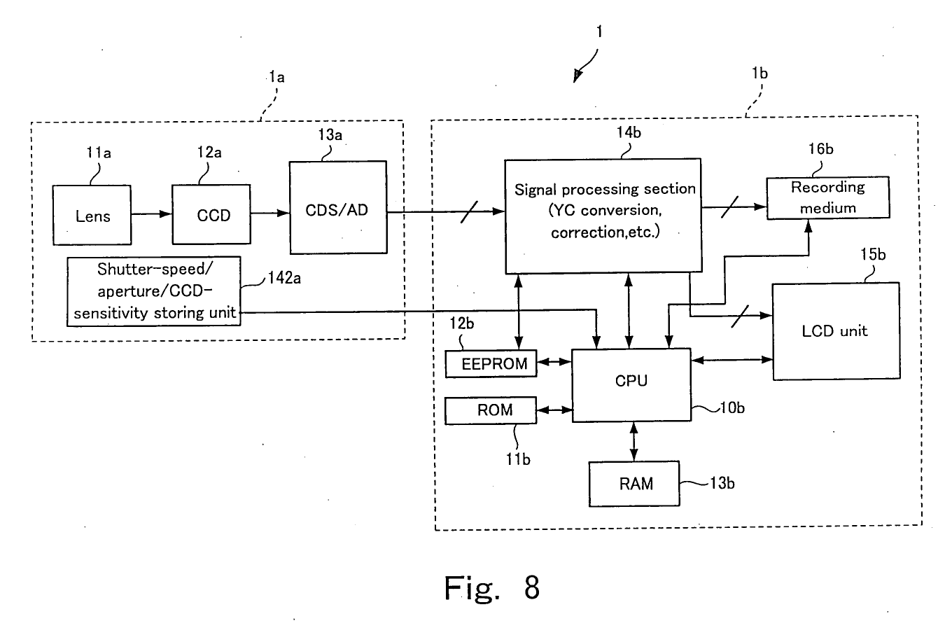

FIG. 8 is a block diagram showing yet another example of the internal structure of the camera system, which provides a shutter-speed/aperture/CCD-sensitivity storing unit 142a that stores aperture information in place of the sensitivity/shutter speed information storing unit 141a shown in FIG. 6.

The image taking optical system of the camera head also includes a diaphragm. Therefore, an improvement is made in this structure in such a way that the aperture information of the diaphragm in addition to the shutter speed and CCD sensitivity information is stored in the shutter-speed/aperture/CCD-sensitivity storing unit 142a.

As mentioned above, the shutter-speed/aperture/CCD-sensitivity storing unit 142a is provided in place of the sensitivity/shutter speed information storing unit 141a in this case. Therefore, based on three kinds of information about shutter speeds, apertures, and CCD sensitivity values, the CPU 10b can obtain an exposure correction acceptable range by calculation and display the obtained range on a display screen. At this point, when any one of exposure correction values displayed on the display screen is selected by the cross key 151b, the CPU 10b sets a parameter according to the selected value in a signal processing unit 14b, drives a CCD 12a at a shutter speed according to the selected value by controlling a timing generator of the camera head, and sets an aperture (not shown) according to the selected value on an optical axis. With this arrangement, an image can be taken based on the corrected exposure without fail. The combination of the CPU 10b and the cross key 151b corresponds to the “exposure correction setting section” and the combination of the components from the image taking optical system including the diaphragm to the signal processing unit 14b corresponds to the “image taking section” according to the present invention.

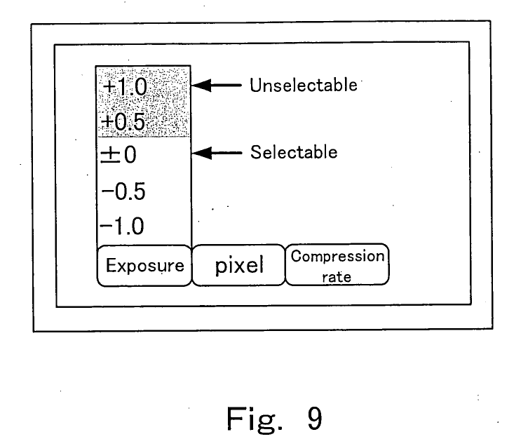

FIG. 9 illustrates a display screen that displays an exposure-correction-value settable range.

As shown in FIG. 9, exposure correction values in a settable range as well as in an unsettable range are displayed on the display screen. Among them, for example, an exposure correction value +1.0 is indicated with a word: “Unselectable.”

With this arrangement, it is possible to notify a user of an exposure-correction-value acceptable range according to the CCD sensitivity and CCD shutter speed properties of the camera head and further according to the property of the diaphragm that limits the mount of light received on the light-receiving surface of the CCD. Further, in this camera system, a CCD shutter speed and an aperture are set according to the exposure correction value selected by the user, and an operational parameter is also set in the signal processing unit 14b according to the selected value. Accordingly, an image can be taken based on the corrected exposure in this camera system.

As described so far, in a camera system according to the invention, every time a camera head is attached, a display screen displays the specifications of an image taking optical system that varies depending on the type of image pickup device, especially the specifications (e.g. sensitivity value, shutter speed, exposure correction value, etc. related to the image-taking property of a CCD. This allows a user to know the property of the camera head without fail. Accordingly, in order to take an image by using the best performance obtained from the combination of a camera main unit and a camera head attached to the camera main unit, a user only needs to look at the image-taking parameters displayed on a display screen without looking up the type of the image pickup device of the camera head in the manual.

As described above, the present invention realizes a camera system for allowing a user to correctly take an image within a sensitivity settable range of the image pickup device of an attached camera head.

What is claimed is:

1. A camera system that includes: plural types of camera heads each incorporating therein an image taking optical system and an image pickup device and having a sensitivity settable range unique to each one of the camera heads; and a camera main unit to which any of the plural types of camera heads is interchangeably attached and which receives an image signal from the attached camera head and performs signal processing,
wherein the camera head comprises:
a sensitivity range recognition section that recognizes a sensitivity settable range of a camera head attached to the camera main unit; and
a display section that displays contents according to the sensitivity settable range recognized by the sensitivity range recognition section.

2. The camera system according to claim 1, wherein the display section displays settable sensitivity values, and
the camera main unit comprises:
a sensitivity setting section that sets any of the settable sensitivity values according to an operation; and
an image taking section that takes an image with the sensitivity value set by the sensitivity setting section.

3. The camera system according to claim 2, wherein the display section displays, in addition to the settable sensitivity values, unsettable sensitivity values in a mode distinguished from the settable sensitivity values.

4. The camera system according to claim 1, wherein the display section displays settable exposure correction values, and
the camera main unit comprises:
an exposure correction setting section that sets any of the settable exposure correction values according to an operation; and
an image taking section that takes an image with exposure corrected according to the exposure correction value set by the exposure correction setting section.

5. The camera system according to claim 4, wherein the display section displays, in addition to the settable exposure correction values, unsettable exposure correction values in a mode distinguished from the settable exposure correction values.

6. The camera system according to claim 1, wherein the display section displays settable shutter speeds, and
the camera main unit comprises:
a shutter speed setting section that sets any of the settable shutter speeds according to an operation; and
an image taking section that takes an image at the shutter speed set by the shutter speed setting section.

7. The camera system according to claim 6, wherein the display section displays, in addition to the settable shutter speeds, unsettable shutter speeds in a mode distinguished from the settable shutter speeds.
